(19) United States
(12) Patent Application Publication
(10) Pub. No.: US 2017/0174307 A1
(43) Pub. Date: Jun. 22, 2017

(54) ACTIVITY MONITORING AND RECORDING SYSTEM AND METHOD

(71) Applicant: ADI Strategy Limited, Chester (GB)

(72) Inventor: Daniel Stuart Endersby, Chester (GB)

(21) Appl. No.: 15/117,126

(22) PCT Filed: Jan. 30, 2015
(86) PCT No.: PCT/GB2015/050253

§ 371 Date: Aug. 5, 2016

(30) Foreign Application Priority Data
Feb. 5, 2014 (GB) 1401976.4

(51) Int. Cl. B63H 25/42; B63B 39/08; G08B 21/18; G06F 17/30; B63B 21/50; B63G 11/00; G07C 5/08

(52) U.S. Cl. CPC B63H 25/42; B63G 11/00; B63B 39/08; G07C 5/085; G06F 17/30241; B63B 21/50; G08B 21/18; B63J 2099/006

(57) ABSTRACT

An activity monitoring and recording system and method are disclosed for monitoring and recording data relating to the dynamic positioning of a vehicle. The system comprises a monitoring arrangement for monitoring data representative of the positional state of the vehicle and data representative of the activity of an operator when controlling a dynamic positioning of the vehicle. The system further comprises a processor, communicatively coupled with the monitoring arrangement, for processing the monitored data, and at least one tag comprising operator identification. The system further comprises a tag interrogating device for interrogating the tag to determine the identity of the operator of the dynamic positioning system, and for recording processed data to the tag.

The present invention relates to an activity monitoring and recording system and method.

### BACKGROUND TO THE INVENTION

Off-shore work is often carried out on floating vessels and platforms which are typically required to remain localised over a particular area of the seabed. The localisation requires continuous supervision and control of the vessel by one or more operators to accommodate factors which act to displace the vessel from the desired location, such as wind speed, wind direction, sea current and the force of the sea current.

The so-called dynamic positioning of the vessel is achieved by the one or more operators controlling several thrusters associated with the vessel, to counter any fore/aft and port/starboard deviations. The operation of these thrusters is expensive and as such, unnecessary or excessive use of the thrusters is undesirable. It is therefore preferable that the vessel is maintained at the desired location with minimal operator intervention.

When training an operator it is desirable to record the activity of the operator so that a supervisor or similar can provide constructive feedback to the operator at a later date. It is also desirable for the operator to keep a record of their activity as an indication of their operating standard.

### SUMMARY OF THE INVENTION

In accordance with a first aspect of the present invention, there is provided an activity monitoring and recording system configured to monitor and record data relating to the dynamic positioning of a vehicle, the system comprising:
a monitoring arrangement configured to monitor data representative of the positional state of the vehicle and data representative of the activity of an operator when controlling a dynamic positioning of the vehicle;
a processor, communicatively coupled with the monitoring arrangement which is configured to process the monitored data;
at least one tag comprising operator identification; and,
a tag interrogating device configured to interrogate the tag to determine the identity of the operator of the dynamic positioning system, and which is configured to record the processed monitored data to the tag.

In an embodiment, the monitoring and recording system is arranged to monitor and record data relating to the dynamic positioning of a maritime vessel, such as a floating maritime platform, in response to a sensed deviation of the vessel from a desired location. The at least one tag comprises a unique operator specific reference, such that the system can determine the identity of the operator of the dynamic positioning system, and a memory store. The memory store is arranged to store data, such as data relating to one or more of a name of the vehicle, such as the maritime vessel name which the operator is to control, an international maritime organisation (IMO) number and the processed data relating to the dynamic positioning of the vessel, which may comprise one or more of a log of the time spent by the operator controlling the dynamic positioning of the vessel and any control signals applied by the operator during an operational shift. In an embodiment, the monitoring and recording system further comprises a separate memory store for recording the processed data.

In an embodiment, the system further comprises communication means, such as a very small aperture terminal (VSAT) communicatively coupled with the processor, for communicating the processed data to a further memory store, such as a server located on-shore.

In accordance with a second embodiment of the present invention there is provided an activity monitoring and recording method configured to monitor and record the dynamic positioning of a vehicle, the method comprising:
interrogating a tag to determine the identity of an operator of the dynamic positioning system;
monitoring data representative of the positional state of the vehicle and data representative of the activity of the operator when controlling a dynamic positioning of the vehicle;
processing the monitored data; and,
recording the processed monitored data to the tag.

In an embodiment, the method further comprises recording the processed data on a memory store, which may comprise a memory store located proximate to the vehicle or remote thereto, such as on-shore.

In accordance with a third aspect of the present invention, there is provided a dynamic positioning system configured to control the dynamic positioning of a vehicle, the system comprising an activity monitoring and recording system of the first aspect.

### BRIEF DESCRIPTION OF THE DRAWINGS

Embodiments of the present invention will now be described by way of example only and with reference to the accompanying drawings in which:

FIG. 1 is a schematic illustration of an activity monitoring and recording system according to an embodiment of the present invention for monitoring and recording data relating to a dynamic positioning of a vehicle; and,

FIG. 2 is a flow chart illustrating the sequence of steps associated with a method according to an embodiment of the present invention.

### DETAILED DESCRIPTION

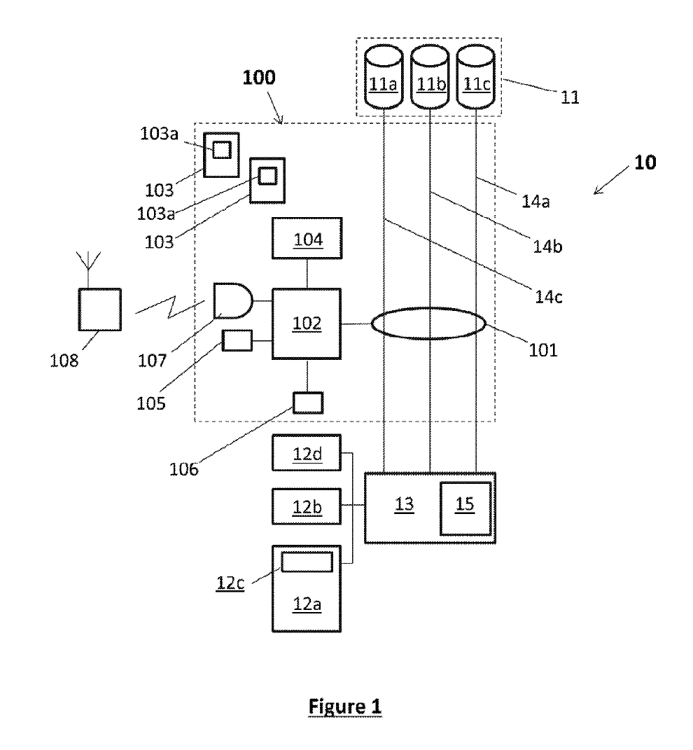

Referring to FIG. 1 of the drawings, there is illustrated a dynamic positioning system 10 for controlling the position of a vehicle, such as a floating vessel or platform (not shown). The dynamic positioning system 10 comprises at least one dynamic positioning processor 11 which is arranged to receive positional data from a plurality of sensors (not shown), the data relating to dynamic positioning parameters of the vessel. The parameters may include one or more of the actual position of the vessel and any fore/aft, port/starboard deviation from the desired position, the vessel heading, wind speed, wind direction, water current force and water current direction. The at least one dynamic positioning processor 11 may also be arranged to receive data relating to any thrusters (not shown) used for manoeuvring the vessel and an operational status of the thrusters, such as offline, active, disabled, inactive.

The dynamic positioning system 10 further comprises an operator interface 12, which may comprise a display screen 12a and one or more input devices, such as a joystick 12b, one or more touch sensitive areas on the screen 12c and/or a keyboard 12d, for example, for enabling one or more operators to interact with the system 10 and enter control signals for operating the thrusters and thus controlling the positioning of the vessel (not shown). The interface further comprises a processor 13 which is arranged to receive as input, data from the at least one dynamic positioning processor 11 and display the data on the display screen 12a.

The data received by the at least one dynamic positioning processor 11 is communicated to the interface processor 13 via a communications link 14, which may comprise a serial communications link, an Ethernet connection, or a process-field-bus (Profibus) or a controller-area-network bus (Canbus), for example. In order to provide some redundancy in the event that the dynamic positioning processor 11 fails, the system 10 may beneficially comprise two or more dynamic positioning processors 11a-c, each dynamic positioning processor 11a-c being communicatively coupled to the interface processor 13 via a respective communications link 14a-c.

FIG. 1 further illustrates an activity monitoring and recording system 100 according to an embodiment of the present invention for monitoring and recording data relating to the dynamic positioning of a vehicle. The monitoring and recording system 100 comprises a monitoring arrangement 101 for monitoring data relating to the positional state of the vessel, namely the dynamic positioning parameters and data relating to the use of any thrusters, which is communicated along the communication links 14a-c. The monitoring arrangement 101 may comprise a direct connection to the dynamic positioning system 10, such as via a similar serial communications connection, an Ethernet connection, or a Profibus or a Canbus. Alternatively, the monitoring arrangement 101 may comprise a network analyser sniffer (not shown) for example, which is arranged to the monitor the transmission of data along the communication links 14a-c. In either case, the monitored data is communicated to a processor 102 associated with the system 100 for subsequent processing.

The monitoring and recording system 100 further comprises one or more operator identification tags 103, such as smart cards, which are interrogable via an interrogation device 104, such as a smart card reader and writer, which is communicatively coupled with the processor 102. Each tag 103 associated with the system 100 is specific to a particular operator and comprises a unique operator identification reference. The tags 103 further comprise a memory store 103a for enabling data to be recorded thereto via the interrogation device 104, such as the name of the vessel and the international maritime organisation or IMO number of the vessel.

The monitoring and recording system 100 may further comprise a display 105 for displaying the operator or operators operating the dynamic positioning system 10 and a keyboard 106, or other well-known input devices for enabling the operator to interface with the monitoring and recording system 100. For example, an operator wishing to review their time spent operating the dynamic positioning system 10 and their operational activity over the operational shift, may interface with the monitoring and recording system 100 using the input device 106 to display the relevant information on the display screen 105. An operator may also interact with the monitoring and recording system 100 via the display 105 and input device 106 to review the operational state of the monitoring arrangement 101 and interrogation device 104, for example.

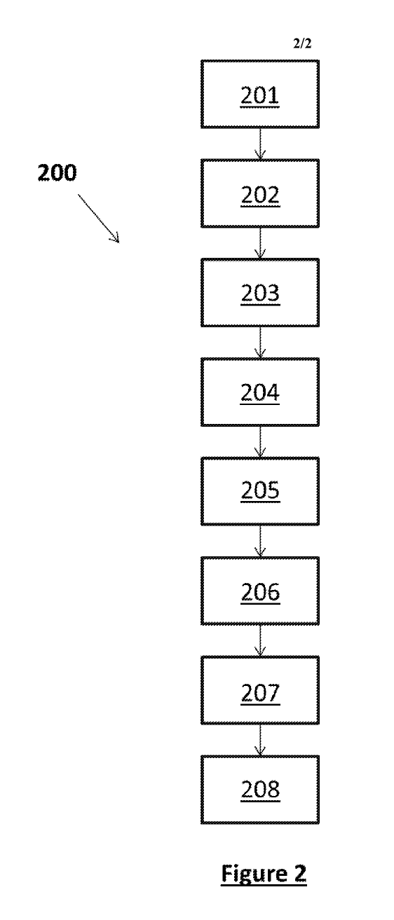

Referring to FIG. 2 of the drawings, there is illustrated an activity monitoring and recording method 200 according to an embodiment of the present invention for monitoring and recording data relating to the dynamic positioning of a vehicle, such as a floating vessel or platform (not shown). One or more operators desiring to control the dynamic positioning of the vessel first enters, swipes or otherwise presents their tag 103 to the interrogation device 104 at step 201, so that the device 104 can interrogate the tag 103 to determine the identity of the at least one operator at step 202. The display 105 associated with the monitoring and recording system 100 subsequently displays the name of the at least one operator who has registered on the system at step 203. If required, the at least one operator may be further required to enter an identification code, such as a personal identification number, via the input device 106, at step 204, to further validate the authenticity of the operator.

In the event that several operators have registered on the system, then the particular operator responsible for entering control signals may be first selected via the input device 106, at step 205, such that the system 100 can associate the activity with the corresponding operator. The particular operator subsequently controls the dynamic positioning of the vessel via the dynamic positioning system interface 12 by varying the operational state of one or more thrusters (not shown) for example, in response to the parameters influencing the vessel position, to maintain a suitable positioning of the vessel. The operator activity, namely the particular control signals applied during the operation of the dynamic positioning system 10 together with the parameters influencing the dynamic positioning of the vessel are monitored by the monitoring arrangement 101 via the communication links 14a-c and recorded by the processor 102 onto a memory store 15 associated with the dynamic positioning system 10 at step 206. The registration of the at least one operator on the monitoring and recording system, enables the system to assign the particular activity to the respective operator, such that the activity of the or each operator can be later reviewed. The operator activity is also recorded on the memory store 103a associated with their respective tag 103, via the interrogation device 104 at step 207 and provides the operator with a personal record of their operational activity.

The system 100 further comprises communication means 107, such as a very small area terminal or VSAT, communicatively coupled to the processor 102 which is arranged to communicate the operator activity, together with the identity of the or each operator to a remote memory store 108, such as server located onshore at step 208. This operator record facilitates a future assessment of operator competence in relation to preferred operational criteria and thus enables a tailored training programme to address the weaker aspects of the operators control.

From the foregoing therefore, it is evident that the system and method provide for a simple yet effective means of monitoring and recording the operator activity.

1. An activity monitoring and recording system configured to monitor and record data relating to the dynamic positioning of a vehicle, the system comprising:
a monitoring arrangement configured to monitor data representative of the positional state of the vehicle and data representative of the activity of an operator when controlling a dynamic positioning of the vehicle;
a processor, communicatively coupled with the monitoring arrangement, which is configured to process the monitored data;
at least one tag comprising operator identification; and,
a tag interrogating device configured to interrogate the tag to determine the identity of the operator of the dynamic positioning system, and which is configured to record the processed monitored data to the tag.

2. A system according to claim 1, wherein the vehicle comprises a maritime vessel.

3. A system according to claim 1, wherein the tag comprises a unique operator reference and a memory store.

4. A system according to claim 3, wherein the memory store comprises data relating to one or more of a name of the vehicle or vessel, an international maritime organisation number.

5. A system according to claim 1, further comprising communication means communicatively coupled with the processor for communicating the operator activity to a further memory store.

6. An activity monitoring and recording method configured to monitor and record data relating to the dynamic positioning of a vehicle, the method comprising:
interrogating a tag to determine the identity of an operator of the dynamic positioning system;
monitoring data representative of the positional state of the vehicle and data representative of the activity of the operator when controlling a dynamic positioning of the vehicle;
processing the monitored data; and,
recording the processed monitored data to the tag.

7. A method according to claim 6, further comprising recording the operator activity on a further memory store.

8. A dynamic positioning system configured to control the dynamic positioning of a vehicle, the system comprising an activity monitoring and recording system according to claim 1.
